(19) United States
(12) Patent Application Publication
(10) Pub. No.: US 2014/0205958 A1
(43) Pub. Date: Jul. 24, 2014

(54) VEHICLE TYPE THERMAL DESORPTION PYROLYSIS SYSTEM

(71) Applicant: E-SUNSCIENCE CO., LTD., Taipei City (TW)

(72) Inventor: Li-Feng CHENG, Taipei City (TW)

(73) Assignee: E-SUNSCIENCE CO., LTD., Taipei City (TW)

(21) Appl. No.: 14/161,149

(22) Filed: Jan. 22, 2014

Related U.S. Application Data
(60) Provisional application No. 61/755,166, filed on Jan. 22, 2013.

(51) Int. Cl. F27D 1/00

(52) U.S. Cl. CPC F27D 1/00
USPC 432/62

(57) ABSTRACT

The present invention discloses a vehicle type thermal desorption pyrolysis system. The system comprises a thermal desorption pyrolysis device and a vehicle. Wherein, the vehicle has a shipping shell. The thermal desorption pyrolysis device is disposed in a containing space of the shipping shell. The vehicle ships the thermal desorption pyrolysis device to move, so that the convenience for using the thermal desorption pyrolysis device can thereby be promoted.

### CROSS-REFERENCE TO RELATED APPLICATION

This application claims the benefit of U.S. patent application Ser. No. 61/755,166, filed on Jan. 22, 2013, in the United States Patent and Trademark Office, the disclosure of which is incorporated herein its entirety by reference.

### BACKGROUND OF THE INVENTION

1. Field of the Invention

The present invention generally relates to a thermal desorption pyrolysis system, in particular with respect to a vehicle type thermal desorption pyrolysis system, which ships the thermal desorption pyrolysis device to move by the vehicle.

2. Description of the Related Art

In the prior art, most of thermal desorption pyrolysis devices are stationary and fixed in working location. Normally, it takes time to assemble the thermal desorption pyrolysis device, so, in case the thermal desorption pyrolysis device needs to be moved from one working location to another, the processes of disassembling, transporting and assembling not only waste time, but also cost a lot.

In addition, most of the stationary thermal desorption pyrolysis devices need to spend time on waiting the heat dissipation, if the user wants to save time and cost, it is inevitable to consume more energy to proceed to dissipate heat, as a result, the cost increases.

In view of the aforementioned problem, the present invention provides a vehicle type thermal desorption pyrolysis system which aims at solving the existing defect and thereby promoting the industrial applicability.

### SUMMARY OF THE INVENTION

One of the purposes of the present invention is to provide a vehicle type thermal desorption pyrolysis system to overcome the Obstacle caused by the prior art.

According to the above-mentioned purpose, the present invention discloses a vehicle type thermal desorption pyrolysis system, comprising a vehicle and a thermal desorption pyrolysis device. Wherein, the vehicle has a shipping shell; and the thermal desorption pyrolysis device is disposed in a containing space of the shipping shell, and shipped by the vehicle so as to move.

Preferably, a plurality of inlet wind shields and a plurality outlet wind shields are disposed on the shipping shell, the plurality of inlet wind shields are disposed adjacent to front end of the shipping shell, and openings of the plurality of inlet wind shields face the front end of the shipping shell, the plurality of outlet wind shields are disposed adjacent to rear end of the shipping shell, top surface of the shipping shell or the combination thereof, and openings of the plurality of outlet wind shields face the rear end of the shipping shell. As a result, wind current of environment is formed as a predetermined flowing direction through the plurality of inlet wind shields and the plurality of outlet wind shields, so as to cool the inner of the shipping shell.

Preferably, the front end of the vehicle is adjusted to face wind direction according to the wind direction of environment, or it may comprise a sensor, and the plurality of inlet wind shields are automatic open/close and control the opening angle of each of the plurality of inlet wind shields according to the result performed by the sensor,

Preferably, the vehicle type thermal desorption pyrolysis system further comprises at least one shock-absorbing thermal barrier to bear the thermal desorption pyrolysis device, the shock-absorbing thermal barrier has a concrete layer, a surface layer with epoxy resin and a base layer with wood or plastic material, and the concrete layer may comprise AlSiO4, the surface layer and the base layer are disposed at two sides of the concrete layer, respectively. Wherein the concrete layer may further comprise a first concrete layer, a second concrete layer and a third concrete layer, the three concrete layers are stacked; the first concrete layer is adjacent to the surface layer, the third concrete layer is adjacent to the base layer.

Preferably, the water-cement ratio of the first concrete layer and the third concrete layer may be the same by less than 0.46, wherein the second concrete layer comprises AlSiO4 by 35% to 65%.

Preferably, the total thickness of at least one shock-absorbing thermal barrier may be 220 to 240 mm; wherein the surface layer is of 2.2% in the total thickness, the first concrete layer, the third concrete layer and the base layer are of 8.7% in the total thickness, respectively, and the second concrete layer is of 71.7% in the total thickness.

Preferably, the base layer may have at least a first fixed portion, the concrete layer may have at least a second fixed portion corresponding to the at least first fixed portion; the concrete layer is fixed in the base layer by the at least first fixed portion and the at least first fixed portion.

Preferably, when there is a plurality of the shock-absorbing thermal barriers, each of the shock-absorbing thermal barriers is disposed at bottom of the containing space of the shipping shell with a gap, and the structures of the side walls of the shock-absorbing thermal barriers adjacent to each other are corresponding serration.

Preferably, the vehicle type thermal desorption pyrolysis system may further comprise at least one rubber gap pad disposing within the gap and the shape thereof is corresponding to the gap.

According the aforementioned description, the vehicle type thermal desorption pyrolysis system has one or more advantages as follows:
(1) The vehicle type thermal desorption pyrolysis system is able to promote the utilization rate and convenience while being removed from location A to location B without consuming extra energy by assembling the thermal desorption pyrolysis device bore on the vehicle, and the difference in the fixed device is that the vehicle type thermal desorption pyrolysis system decreases the cost of transporting the material as well as the fixed cost of idling the fixed device. Consequently, compared with the traditional thermal desorption pyrolysis system, the vehicle type thermal desorption pyrolysis system therefore promotes the utilization rate.
(2) Because the vehicle type thermal desorption pyrolysis system is removable, the traditional obstacle to the more complicated, long-distance engineering project as well as the transportation of waste disposal can thereby be bettered, and the service for industries and communities can be tailor-made, too. As a result, the utilization rate of the device can be promoted and the pollution of Sox, NOx and CO can be reduced.
(3) Compared with the traditional thermal desorption pyrolysis system, the vehicle type thermal desorption pyrolysis system makes good use of the arrangement of the inlet wind shield and the outlet wind shield along with the wind chill to cool down while the vehicle is moving.
(4) Because AlSiO4, which is contained in the concrete layer, is characteristic of thermal insulation, of which can lower the negative influence generated by the thermal desorption pyrolysis device upon the vehicle. In addition, the thermal desorption pyrolysis device may have damage to the equipment or the junction pipeline may fall off while transporting, so, by means of the shock-absorbing thermal barrier, the possibility can thus be reduced greatly.
(5) Generally, the throughput and the disposing land of the fixed thermal desorption pyrolysis device are relatively huge on account of the economic factor in batch production, and as far as the smaller using terminal is concerned (e.g. resource recycling station), relatively, the processing procedures of recycling is much easier, benefiting from the investment and efficiency. Therefore, compared with the fixed one, the vehicle type thermal desorption pyrolysis system saves the land occupation.

### BRIEF DESCRIPTION OF THE DRAWINGS

FIG. 1 is first schematic view of a vehicle type thermal desorption pyrolysis system of the present invention.

FIG. 2 is second schematic view of a vehicle type thermal desorption pyrolysis system of the present invention.

FIG. 3 is third schematic view of a vehicle type thermal desorption pyrolysis system of the present invention.

FIG. 4 is fourth schematic view of a vehicle type thermal desorption pyrolysis system of the present invention.

FIG. 5 is fifth schematic view of a vehicle type thermal desorption pyrolysis system of the present invention.

FIG. 6 is sixth schematic view of a vehicle type thermal desorption pyrolysis system of the present invention.

FIG. 7 is seventh schematic view of a vehicle type thermal desorption pyrolysis system of the present invention.

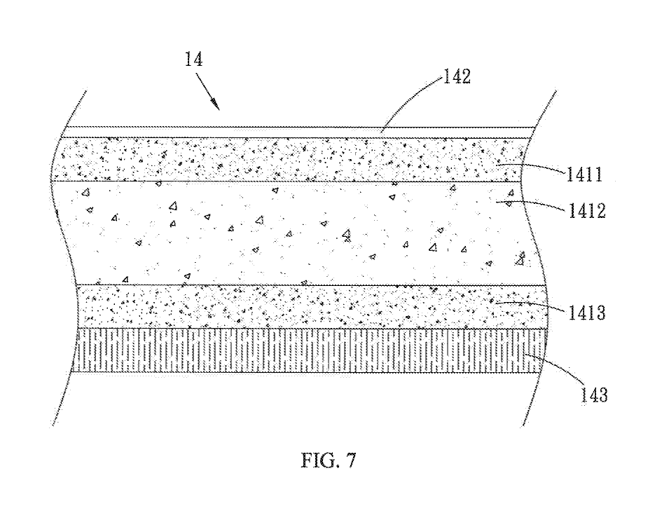

FIG. 8 is eighth schematic view of a vehicle type thermal desorption pyrolysis system of the present invention.

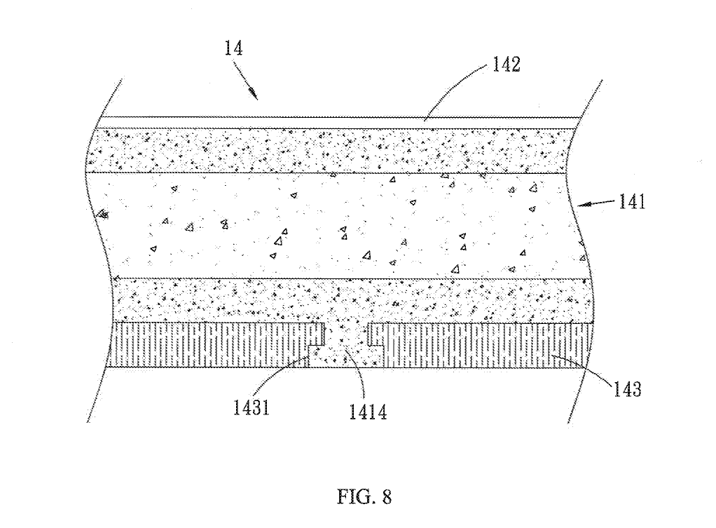

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

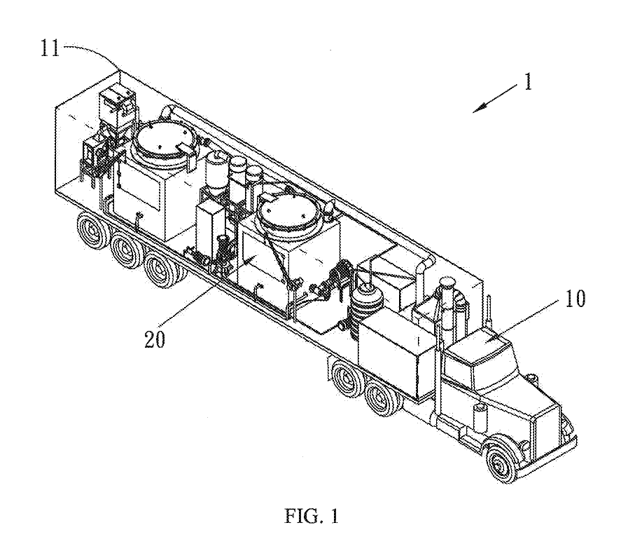

With reference to FIG. 1 for first schematic view of a vehicle type thermal desorption pyrolysis system of the present invention.

As FIG. 1 shows, the vehicle type thermal desorption pyrolysis system 1 of the present embodiment comprises a vehicle 10 and a thermal desorption pyrolysis device 20. Preferably, the vehicle 10 may be a large vehicle, such as a wagon, a lorry or a trailer and so on, and a shipping shell 11 is disposed in the rear of the head of the vehicle 10, the thermal desorption pyrolysis device 20 is disposed in a containing space of the shipping shell 11. In the practical application, the vehicle 10 may be used to ship the vehicle type thermal desorption pyrolysis system 1 of the present invention so that the thermal desorption pyrolysis device 20 is removable. That is to say, after the vehicle type thermal desorption pyrolysis system 1 finished the thermal desorption pyrolysis in location A, the vehicle 10 can remove the thermal desorption pyrolysis device 20 from location A to location B and proceed to the thermal desorption pyrolysis in location B. By this way, the utilization rate and the convenience of the thermal desorption pyrolysis device 20 can thereby be promoted efficiently,

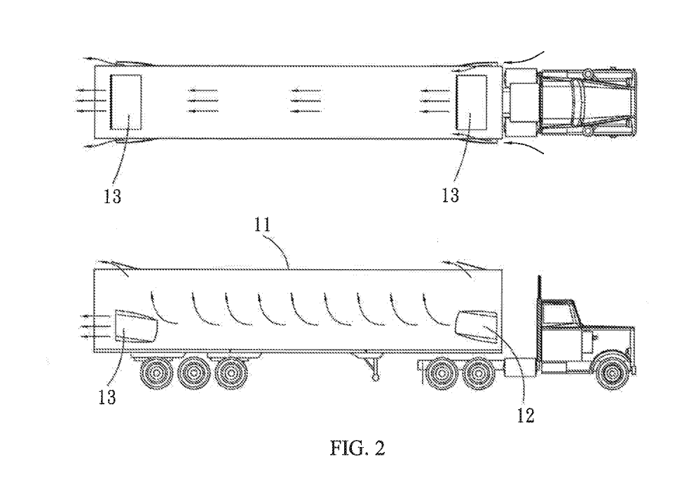

With reference to FIG. 2 for second schematic view of a vehicle type thermal desorption pyrolysis system of the present invention.

As FIG. 2 shows, a plurality of inlet wind shields 12 and a plurality of outlet wind shields 13 are disposed on the shipping shell 11. Wherein the plurality of inlet wind shields 12 may be disposed adjacent to front end of the shipping shell 11, and openings of the plurality of inlet wind shields 12 face the front end of the shipping shell 11, for example two sides or top end of the shipping shell 11 which is adjacent to the front end of the shipping shell 11. That is to say, the plurality of inlet wind shields 12 are disposed adjacent to the head of the vehicle 10, and while the vehicle 10 is moving, the plurality of inlet wind shields 12 can receive wind current of environment. The plurality of outlet wind shields 13 are disposed adjacent to the rear end, top surface or the combination thereof corresponding to the plurality of inlet wind shields 12 so as to discharge the wind current of environment received by the plurality of inlet wind shields 12.

While the thermal desorption pyrolysis device 20 is working, it usually generates huge heat energy, so that the temperature of the thermal desorption pyrolysis device 20, the vehicle 10 and the shipping shell 11 increases, When the vehicle 10 is moving, the wind current of environment is formed as a predetermined flowing direction through the plurality of inlet wind shields 12 and the plurality of outlet wind shields 13 so as to cool down the inner of the shipping shell 11 efficiently. Consequently, the vehicle type thermal desorption pyrolysis system 1 of the present invention can conduct heat dissipation itself without extra cost or energy consumption.

It is noteworthy that when the vehicle 10 is in idle mode, the operation personnel can adjust the position of the vehicle 10 according to the wind current of environment, so that the front end of the vehicle 10 can face the windward. Therefore, even if the vehicle 10 is in idle mode, it can still guide the wind current to cool down toward itself efficiently without consuming extra energy.

In a preferable application, the vehicle type thermal desorption pyrolysis system 1 may comprise a sensor (not shown in the FIG.) which can be disposed on the top portion of the vehicle 10 or the top portion of the shipping shell 11, and electrically connect to CAN BUS of the vehicle 10 or an independent processor to sense the wind direction of environment. The plurality of inlet wind shields 12 may have an automatic open/close module which enables the plurality of inlet wind shields 12 becoming automatic open/close wind shield. When the vehicle 10 is in idle mode, the sensor can sense the wind direction of the environment and control the opening angle or direction to guide the wind current to cool down according to the result performed by the sensor. As a result, the vehicle type thermal desorption pyrolysis system 1 can conduct guiding the wind current to cool down without removing the vehicle 10.

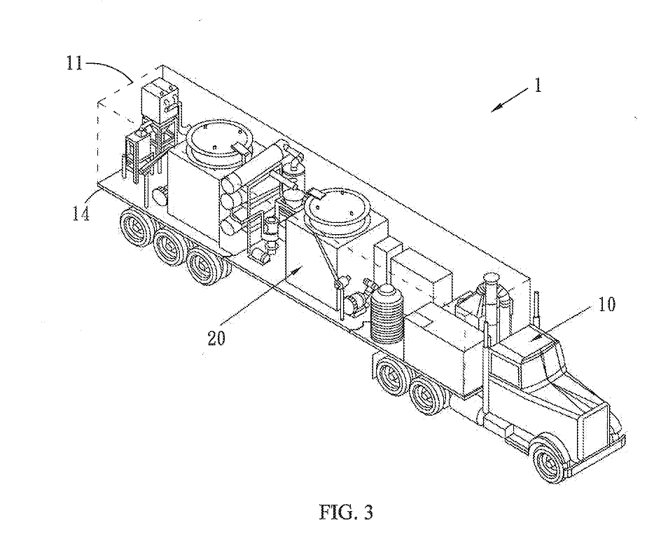

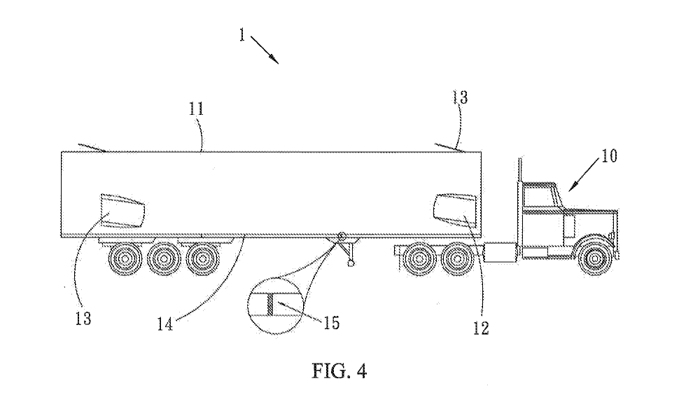

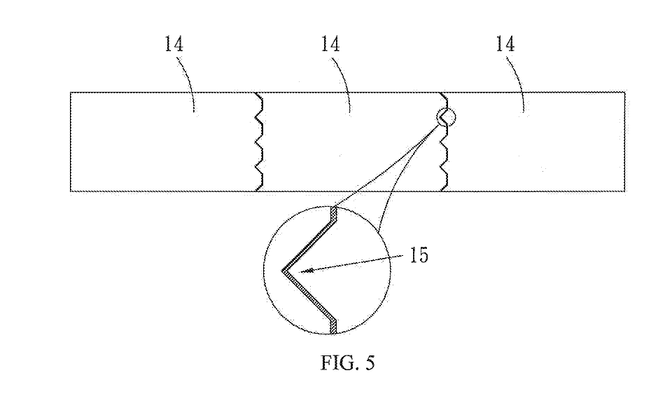

With reference to FIGS. 3 to 5 for third to fifth schematic views of a vehicle type thermal desorption pyrolysis system of the present invention.

In the real situation, roads are normally not flat, so it is inevitable that the thermal desorption pyrolysis device 20 must encounter the shock while the thermal desorption pyrolysis device 20 bore by the vehicle 10 is moving. In case the obstacle to the shock cannot be overcome, it may cause damage to the equipment when the thermal desorption pyrolysis device 20 moves. Hence, the vehicle type thermal desorption pyrolysis system 1 further disposes with a shock-absorbing thermal barrier 14 at the bottom of the shipping shell 11 to bear the thermal desorption pyrolysis device 20, as well as solves the shock toward the thermal desorption pyrolysis device 20.

In the present embodiment, the shock-absorbing thermal barrier 14 is numerous, but in the practical application, it can be one, so it shall not be subject to this restriction. As FIGS. 3 to 5 show, the inner bottom of the shipping shell 11 may be disposed with a plurality of shock-absorbing thermal barriers 14 and each of which is disposed at bottom of the containing space of the shipping shell 11 with a gap to bear the thermal desorption pyrolysis device 20. Wherein the structures of the side walls of the shock-absorbing thermal barriers 14 adjacent to each other are corresponding serration, and rubber gap pads 15 are disposed among each gap, the arrangement thereof is like expansion gap of bridge. The further technical characteristic thereof is known toward a technician in the art, so unnecessary details are no longer given hereinafter. By the way, the shock-absorbing thermal barriers 14 may use the side walls, which are structures of serration, along with the gap pads 15 to avoid the malposition so as to absorb the shock while having shock or action force.

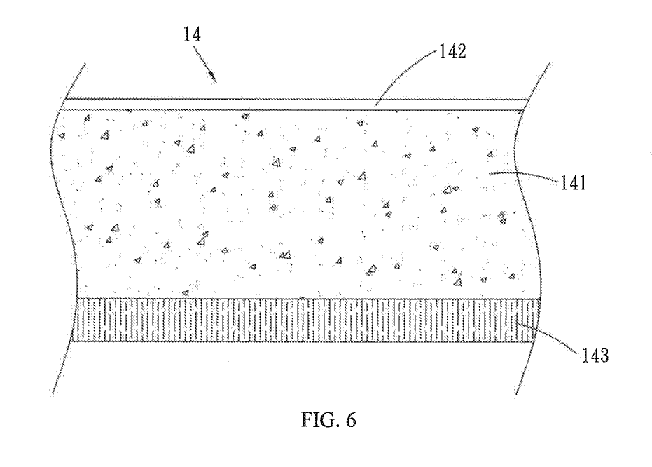

With reference to FIGS. 6 to S for sixth to eighth schematic views of a vehicle type thermal desorption pyrolysis system of the present invention.

Specifically, the shock-absorbing thermal barriers 14 comprise a concrete layer 141, a surface layer 142 and a base layer 143. Wherein the concrete layer 141 comprises a first concrete layer 1411, a second concrete layer 1412 and a third concrete layer 1413, and the three concrete layers 1411,1412,1413 are stacked are stacked. The water-cement ratio of the first concrete layer 1411 and the third concrete layer 1413 may be the same by less than 0.46, and the second concrete layer 1412 comprises AlSiO4 by 35% to 65%. The surface layer 142 and the base layer 143 are disposed at two sides of the concrete layer 141, respectively. The surface layer 142 may be made of epoxy resin, and disposed at a side of the concrete layer 141 adjacent to the first concrete layer 1411. The base layer 143 may be made of wood or plastic material and disposed at the other side of the concrete layer 141 adjacent to the third concrete layer 1413. By the way, an adequate ratio to water-cement is of better strength, and the strength will become weaker in case the water-cement ratio is over 0.46.

Wherein the total thickness of the shock-absorbing thermal barriers 14 may be 220 to 240 mm, and the surface layer 142 is of 2.2% in the total thickness, the first concrete layer 1411 is of 8.7% in the total thickness, the second concrete layer 1412 is of 71.7% in the total thickness and the third concrete layer 1413 is of 8.7% in the total thickness and the base layer is of 8.7% in the total thickness. In case there is adequate material, the thickness of each layers can further be adjusted, and the thickness is corresponding to the ingredient of the material as well as the weight of the objective which is desirable to bear, so that the elastic coefficient and damping value, which are served as reference for bearing objective, can simply obtained.

It is noteworthy that the shock-absorbing thermal barriers 14 can have the adequate elastic coefficient and damping value by means of the aforementioned arrangement in the present embodiment. When the shock-absorbing thermal barriers 14 are used to bear the thermal desorption pyrolysis device 20, the surface layer 142 may be served as a bearing surface to bear objective adequately on account of the characteristics of pressure, resistance, non-slip and so on. The natural frequency of the shock-absorbing thermal barriers 14 can be increased or decreased according to the adequate elastic coefficient and damping value obtained by combining the three layers. As a result, the shock-absorbing thermal barriers 14 not only have sufficient rigidity, but also shock-absorbing ability so that a better bearing can thereby be provided. On the other hand, as the concrete layer 141 comprises AlSiO₄, the characteristic can be used to block the heat energy from being transmitted between the vehicle 10 and the thermal desorption pyrolysis device 20.

In addition, for the sake of combining the concrete layer 141 with the base layer 143 stably, at least a first fixed portion 1413 may be disposed on the base layer 143, at least a second fixed portion 1414 may be disposed on the concrete layer 141 (e.g. third concrete layer 1413) corresponding to the at least first fixed portion 1414. The concrete layer 141 may be fixed with the base layer 143 stably on account of the second fixed portion 1414 is fixed in the first fixed portion 1413. By the way, wherein the first fixed portion 1413 fixes with the second fixed portion 1414 that belongs to the known skill toward a technician in the art, for example a hook structure is formed in the concrete layer 141 and a connection portion is formed in the base layer 1413, and thus, unnecessary details are no longer given, and it shall not construed as limited to the exemplary embodiments set forth herein.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A vehicle type thermal desorption pyrolysis system, comprising:
a vehicle having a shipping shell; and
a thermal desorption pyrolysis device disposed in a containing space of the shipping shell, and shipped by the vehicle so as to move.

2. The system of claim 1, wherein a plurality of inlet wind shields and a plurality outlet wind shields are disposed on the shipping shell, the plurality of inlet wind shields are disposed adjacent to front end of the shipping shell, and openings of the plurality of inlet wind shields face the front end of the shipping shell, the plurality of outlet wind shields are disposed adjacent to rear end of the shipping shell, top surface of the shipping shell or the combination thereof, and openings of the plurality of outlet wind shields face the rear end of the shipping shell,

3. The system of claim 2, wherein wind current of environment is formed as a predetermined flowing direction through the plurality of inlet wind shields and the plurality of outlet wind shields, so as to cool down the inner of the shipping shell.

4. The system of claim 3, wherein the front end of the vehicle is adjusted to face wind direction according to the wind direction of environment.

5. The system of claim 3, wherein further comprises a sensor, the plurality of inlet wind shields are automatic open/close and control the opening angle of each of the plurality of inlet wind shields according to the result performed by the sensor.

6. The system of claim 1, wherein further comprises at least one shock-absorbing thermal barrier bearing the thermal desorption pyrolysis device, the shock-absorbing thermal barrier comprises a concrete layer, a surface layer and abase layer, and the concrete layer comprises AlSiO₄, the surface layer and the base layer are disposed at two sides of the concrete layer, respectively.

7. The system of claim 6, wherein the concrete layer comprises a first concrete layer, a second concrete layer and a third concrete layer, wherein the three concrete layers are stacked, the first concrete layer is adjacent to the surface layer, and the third concrete layer is adjacent to the base layer.

8. The system of claim 7, wherein the second concrete layer comprises AlSiO₄ by 35% to 65%.

9. The system of claim 6, wherein when there is a plurality of the shock-absorbing thermal barriers, each of the shock-absorbing thermal barriers is disposed at bottom of the containing space of the shipping shell with a gap.

10. The system of claim 9, wherein the structures of the side walls of the shock-absorbing thermal barriers adjacent to each other are corresponding serration.

11. The system of claim 10, wherein further comprises at least one gap pad disposing within the gap and the shape of the at least one gap pad is corresponding to the gap.

12. The system of claim 11, wherein the at least one gap pad is made of rubber.
